(19) United States
(12) Patent Application Publication
(10) Pub. No.: US 2015/0174567 A1
(43) Pub. Date: Jun. 25, 2015

(54) HYBRID PHOTOCATALYST FOR WASTEWATER REMEDIATION

(71) Applicants: MOHAMMED ASHRAF GONDAL, DHAHRAN (SA); XIAOFENG CHANG, NANJING CITY (CN); MOHAMMAD ASHRAF ALI, DHAHRAN (SA); MOHAMED ABDULKADER DASTAGEER, DHAHRAN (SA); SYED M. ZUBAIR, DHAHRAN (SA); JOHN H. LIENHARD, V, LEXINGTON, MA (US)

(72) Inventors: MOHAMMED ASHRAF GONDAL, DHAHRAN (SA); XIAOFENG CHANG, NANJING CITY (CN); MOHAMMAD ASHRAF ALI, DHAHRAN (SA); MOHAMED ABDULKADER DASTAGEER, DHAHRAN (SA); SYED M. ZUBAIR, DHAHRAN (SA); JOHN H. LIENHARD, V, LEXINGTON, MA (US)

(73) Assignees: MASSACHUSETTS INSTITUTE OF TECHNOLOGY, CAMBRIDGE, MA (US); KING FAHD UNIVERSITY OF PETROLEUM AND MINERALS, DHAHRAN (SA)

(21) Appl. No.: 14/580,166

(22) Filed: Dec. 22, 2014

Related U.S. Application Data
(60) Provisional application No. 61/918,863, filed on Dec. 20, 2013.

(51) Int. Cl. B01J 31/26; B01J 37/02; B01J 35/00; C02F 1/32; C02F 1/74

(52) U.S. Cl. CPC B01J 31/26; C02F 1/32; C02F 1/74; B01J 35/004; B01J 37/0215; B01J 37/0236; C02F 2101/308

(57) ABSTRACT

The hybrid photocatalyst for wastewater remediation is a composite of rhodamine B and BiOBr. The rhodamine B has a concentration between about 0.1 wt % and about 1 wt % of the overall photocatalyst. The hybrid photocatalyst is made by immersing a BiOBr semiconductor in an aqueous rhodamine B solution to form the hybrid photocatalyst by sorption of the rhodamine B by the BiOBr semiconductor. In use, the hybrid photocatalyst is added to wastewater containing at least one contaminant, such as methyl orange (sodium 4-[(4-dimethylamino)phenyldiazenyl]benzenesulfonate), to form a suspension of the hybrid photocatalyst and the at least one contaminant. The suspension is then exposed to visible to light to form a slurry containing a reaction mixture in the wastewater. The slurry is then filtered to remove the reaction mixture.

### CROSS-REFERENCE TO RELATED APPLICATION

This application claims the benefit of U.S. Provisional Patent Application Serial No. 61/918,863, filed on Dec. 20, 2013.

### BACKGROUND OF THE INVENTION

1. Field of the Invention

The present invention relates to wastewater remediation, and particularly to hybrid photocatalyst for wastewater remediation made of rhodamine B (RhB) and BiOBr.

2. Description of the Related Art

Wastewater from plants, such as those in the textile and leather industries, is often contaminated with organic pollutants, such as dyes, resulting in ecological and health problems in the surrounding areas. Rhodamine B ([9-(2-carboxyphenyl)-6-diethylamino-3-xanthenylidene]-diethylammonium chloride) is a common dye found to contaminate wastewater and is of great concern, as rhodamine B is suspected to be carcinogenic. Once rhodamine B has been removed from the wastewater, during wastewater remediation, it would obviously be desirable to be able to recycle the recovered rhodamine B.

There are a wide variety of methods for performing wastewater reclamation. However, such methods typically require large scale plants and great investments of time, energy and money in order to operate. In developing parts of the world, where resources are often limited, it is extremely difficult to implement large scale wastewater reclamation due to these factors. It would obviously be desirable to provide wastewater filtration and reclamation using a relatively cheap and easy process which takes advantage of materials and resources which are readily available. Photocatalysts are of great interest, as their primary energy source for wastewater remediation is ambient light. TiO₂ is a common photocatalyst for such purposes. However the catalytic activity only takes place in the ultraviolet spectrum, below 370 nm, thus making it relatively ineffective for solar radiation. Photodegradation on the pure phase of BiOBr is presently being explored, as some photocatalytic activity has been observed under visible light, but the results, thus far, have shown that contaminant removal using BiOBr in visible light is relatively inefficient.

Thus, a hybrid photocatalyst for wastewater remediation solving the aforementioned problems is desired.

### SUMMARY OF THE INVENTION

The hybrid photocatalyst for wastewater remediation is a composite of rhodamine B and BiOBr. The rhodamine B may have a concentration between about 0.1 wt % and about 1 wt % of the overall photocatalyst. The hybrid photocatalyst is made by immersing a BiOBr semiconductor in an aqueous rhodamine B solution to form the hybrid photocatalyst by sorption of the rhodamine B by the BiOBr semiconductor. In use, the hybrid photocatalyst is added to wastewater containing at least one contaminant, such as methyl orange (sodium 4-[(4-dimethylamino)phenyldiazenyl]benzenesulfonate), to form a suspension of the hybrid photocatalyst and the at least one contaminant. The suspension is then exposed to visible light to form a slurry containing a reaction mixture in the wastewater. The slurry is then filtered to remove the reaction mixture.

These and other features of the present invention will become readily apparent upon further review of the following specification.

### BRIEF DESCRIPTION OF THE DRAWINGS

FIG. 1 is the FT-IR spectrum of a hybrid photocatalyst for wastewater remediation according to the present invention.

FIG. 2 is the UV-VIS spectrum of the hybrid photocatalyst for wastewater remediation according to the present invention.

FIG. 3 is the photoluminescence (PL) spectra of the hybrid photocatalyst for wastewater remediation according to the present invention.

FIG. 4 is a graph showing a comparison of methyl orange (MO) removal from wastewater as a function of time using the hybrid photocatalyst compared against a conventional BiOBr photocatalyst.

FIG. 5 is a graph showing a comparison of methyl orange (MO) removal, as a function of photocatalyst dosage, from wastewater using the hybrid photocatalyst compared against a conventional BiOBr photocatalyst using visible light having a wavelength greater than 420 nm.

FIG. 6 is a graph showing a comparison of methyl orange (MO) removal from wastewater as a function of photocatalyst dosage using the hybrid photocatalyst compared against a conventional BiOBr photocatalyst using green light.

FIG. 7 is a graph showing a comparison of methyl orange (MO) removal from wastewater as a function of MO concentration using the hybrid photocatalyst compared against a conventional BiOBr photocatalyst using visible light.

Similar reference characters denote corresponding features consistently throughout the attached drawings.

### DETAILED DESCRIPTION OF THE PREFERRED EMBODIMENTS

The hybrid photocatalyst for wastewater remediation is a rhodamine B/BiOBr hybrid material. Rhodamine B ([9-(2-carboxyphenyl)-6-diethylamino-3-xanthenylidene]-diethylammonium chloride) is a common dye found to contaminate wastewater, thus the hybrid photocatalyst for wastewater remediation may be made from a wastewater contaminant, which is removed from the wastewater and recycled as part of the hybrid photocatalyst. The hybrid photocatalyst may be used for removing contaminants from wastewater, such as the removal of azo dyes, which are typically present in textile manufacturing wastewater. The hybrid photocatalyst is operable in sunlight (i.e., in the visible light range).

In order to examine the effectiveness of the hybrid photocatalyst for wastewater remediation, a sample of the hybrid photocatalyst was prepared for comparison against a sample of conventional pure phase BiOBr photocatalyst. The hybrid photocatalyst has a rhodamine B loading amount of between 1 mg/g and 10 mg/g (i.e., the rhodamine B concentration is between 0.1 wt % and 1 wt %). The remainder of the photocatalyst is BiOBr. The hybrid photocatalyst was synthesized by a facile immersion-adsorption process; i.e., by immersing a BiOBr semiconductor in an aqueous rhodamine B solution (with concentration of 1-7 ppm) under dark conditions. The final product of the hybrid photocatalyst was obtained by filtering and drying the solid sample under dark conditions after sorption for 8 to 12 hours.

Alternatively, a fine BiOBr powder may be added to the rhodamine B solution to form a mixture, and this mixture is then agitated at room temperature for about six hours. The mixture is then dried at a temperature of 50-90° C. to produce a solid powder of the rhodamine B/BiOBr hybrid photocatalyst.

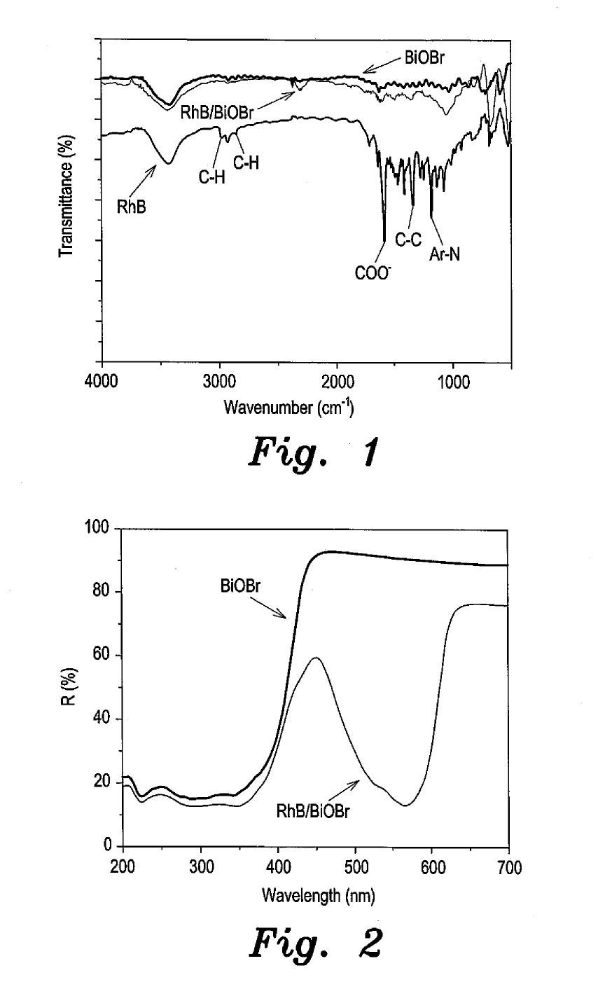

FIG. 1 shows the Fourier transform infrared spectroscopy (FT-IR) characterization of the prepared rhodamine B/BiOBr hybrid photocatalyst (with a rhodamine B loading of 7 mg/g). The surface chemical structure of the rhodamine B/BiOBr hybrid photocatalyst sample was characterized by FT-IR measurements, with strong peaks appearing at 1334 nm⁻¹ and 1178 nm⁻¹, which may indicate stretching vibrations of C—CH₃ and Ar—N, respectively. The peak seen at 1470 nm⁻¹ and 1076 nm⁻¹ are assigned to the stretching vibrations of —C═C—in benzene and C—O—C, respectively. Additionally, the broad band centered at 3433 nm⁻¹ and the band at 1615 nm⁻¹ correspond to the stretching and bending vibrations of 0-H, respectively. Some of the characteristic absorption peaks of rhodamine B (RhB) could not be detected, possibly due to the detection limit of FT-IR. A new weak peak at 2301 nm⁻¹ suggests interaction between the rhodamine B (RhB) and BiOBr species.

FIG. 2 shows the UV-VIS diffuse reflectance spectrum (DRS) spectra of the rhodamine B/BiOBr hybrid photocatalyst (prepared with a rhodamine B loading of 7 mg/g). BiOBr can slightly absorb visible light, and the band gap energy (E_{g}) of BiOBr was estimated to be around 2.9 eV using the Kubelka-Munk function. The adsorption peak centered at 560 nm in the spectrum of the rhodamine B/BiOBr hybrid photocatalyst sample corresponds to the characteristic absorption of rhodamine B. The UV-VIS diffuse reflectance spectrum was obtained using a UV-VIS spectrophotometer equipped with an integration sphere at room temperature.

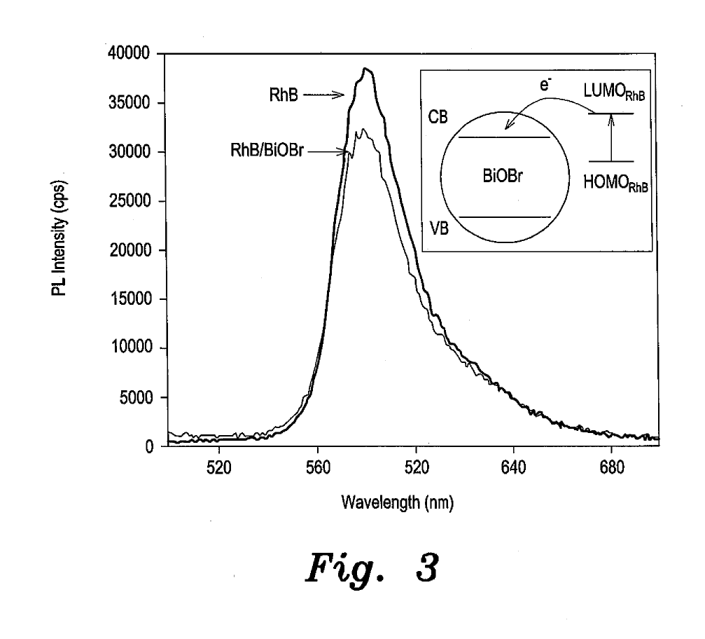

FIG. 3 shows the photoluminescence (PL) spectra of the rhodamine B/BiOBr hybrid photocatalyst sample. The photoluminescence intensity of the rhodamine B aqueous solution apparently weakened after immersing into BiOBr semiconductor in the aqueous solution. This indicates the lifetime of photo-generated electrons in rhodamine B molecules that could be increased in the presence of BiOBr semiconductor; i.e., the photo-generated electrons might partially inject into the conduction band of BiOBr under light excitation. The photoluminescence (PL) spectra were recorded on a spectrofluorometer.

Experiments were performed using a methyl orange (MO) azo dye (sodium 4-[(4-dimethylamino)phenyldiazenyl]benzenesulfonate), as an exemplary wastewater contaminant. MO is considered to be one of the most hazardous dye pollutants present in textile wastewater. All reagents and MO solutions used in the experiments were prepared from analytical grade chemicals of high purity (99.99%). De-ionized water was used for preparation of solutions. For the photodegradation evaluation, visible light (λ>420 nm) and green light (λ=550±10 nm) from a broad band xenon lamp with a power of 300 Watts was used. The xenon lamp included a 420 nm cut-off filter and a 550 bandpass filter, respectively. The rhodamine B/BiOBr photocatalyst was added into an MO aqueous solution to form a suspension containing MO and the rhodamine B/BiOBr hybrid photocatalyst. The suspension was irradiated using the xenon lamp with continuous stirring. The slurry of reaction mixture was taken out and filtered to remove the rhodamine B/BiOBr hybrid photocatalyst at varying time intervals. The concentration of the MO pollutant in aqueous solution was monitored by a UV-VIS spectrometer.

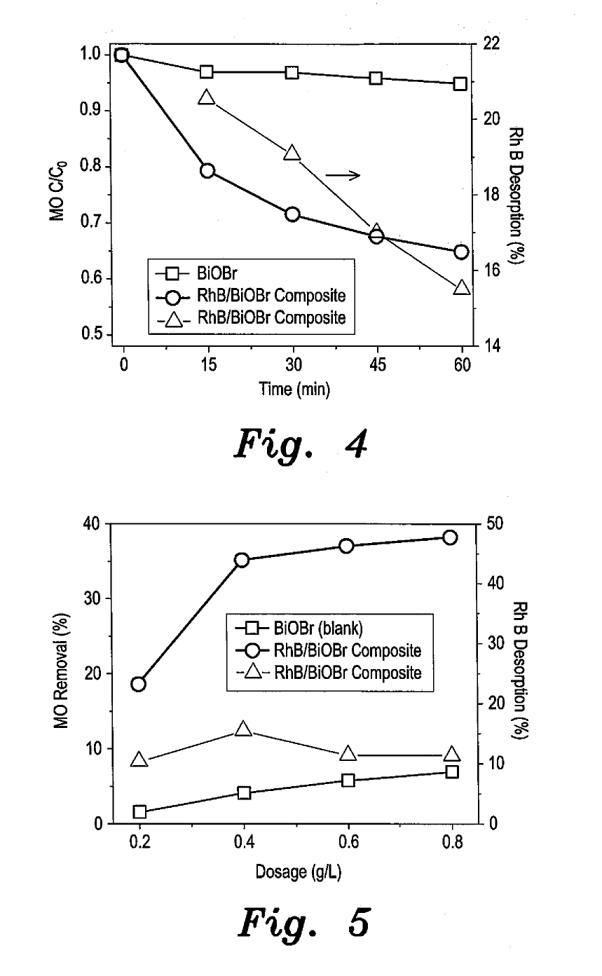

An identical procedure to the above was carried out with a typical BiOBr photocatalyst sample. The data provided in FIG. 4 and Table 1 below show the variations in MO concentrations in water using the UV-VIS spectra over the BiOBr and rhodamine B/BiOBr hybrid photocatalyst samples under visible light irradiation (λ>420 nm). The change in percentage of desorption of rhodamine B (RhB) molecules from the rhodamine B/BiOBr hybrid photocatalyst as a function of irradiation time is also shown,

As clearly shown in FIG. 4, the rhodamine B/BiOBr hybrid photocatalyst has greater photocatalytic efficiency to degrade MO within one hour. Only 5% of MO was removed after one hour of reaction time using the BiOBr sample, whereas about 35% of MO dye molecules were degraded in the same irradiation time using the hybrid photocatalyst. As soon as the photocatalyst was suspended in aqueous solution, a desorption process of rhodamine B on the BiOBr started. After an interaction duration of 15 minutes, about 21% of rhodamine B molecules desorbed from the surface of the BiOBr to the bulk phase of MO solution, and about 6% of the rhodamine B was decomposed synergistically with the photodegradation of MO. Table 1 below compares removal of MO by the hybrid photocatalyst and the conventional BiOBr photocatalyst as a function of irradiation time (C₀(MO)=24 ppm, dosage=0.02 g/25 mL).

TABLE 1
Percent Removal of MO by Hybrid Photocatalyst and BiOBr Photocatalyst

Irradiation time (min)

| Photocatalyst | 15 | 30 | 45 | 60 |
|---|---|---|---|---|
| Rhodamine B/BiOBr | 22% | 30% | 33% | 36% |
| BiOBr | 5% | 5% | 6% | 7% |

FIG. 5 and Table 2 below show that the rhodamine B/BiOBr hybrid photocatalyst provides a greater photocatalytic performance than that of conventional BiOBr, regardless of the change of dosage under visible light irradiation (λ>420 nm). At a dosage of 0.2 g/L, the MO removal of the rhodamine B/BiOBr hybrid photocatalyst is 18.3%, compared with only a 1.9% MO removal using BiOBr. The MO removal of the rhodamine B/BiOBr hybrid photocatalyst increases dramatically to 39.2% using a dosage of 0.8 g/L. To the contrary, the MO removal of the BiOBr increases only slightly to about 6.1% when the dosage was increased to maximum. When the dosage is 0.4 g/L, desorption of rhodamine B reaches only 15% of the maximum, and as the dosage increases, the rhodamine B decreases to 11% and then holds steady. Table 2 below shows the percent degradation of MO by the hybrid rhodamine B/BiOBr photocatalyst (rhodamine B loading of 7 mg/g) compared against the conventional BiOBr photocatalyst as a function of catalyst dosage (irradiation time of 60 min, C₀(MO)=24 ppm, volume of solution=25 mL).

TABLE 2
Percent Degradation of MO by Hybrid Photocatalyst and
BiOBr photocatalyst

Dosage (g/L)

| Photocatalyst | 0.2 | 0.4 | 0.6 | 0.8 |
|---|---|---|---|---|
| Rhodamine B/BiOBr | 18% | 35% | 37% | 39% |
| BiOBr | 2% | 4% | 5% | 6% |

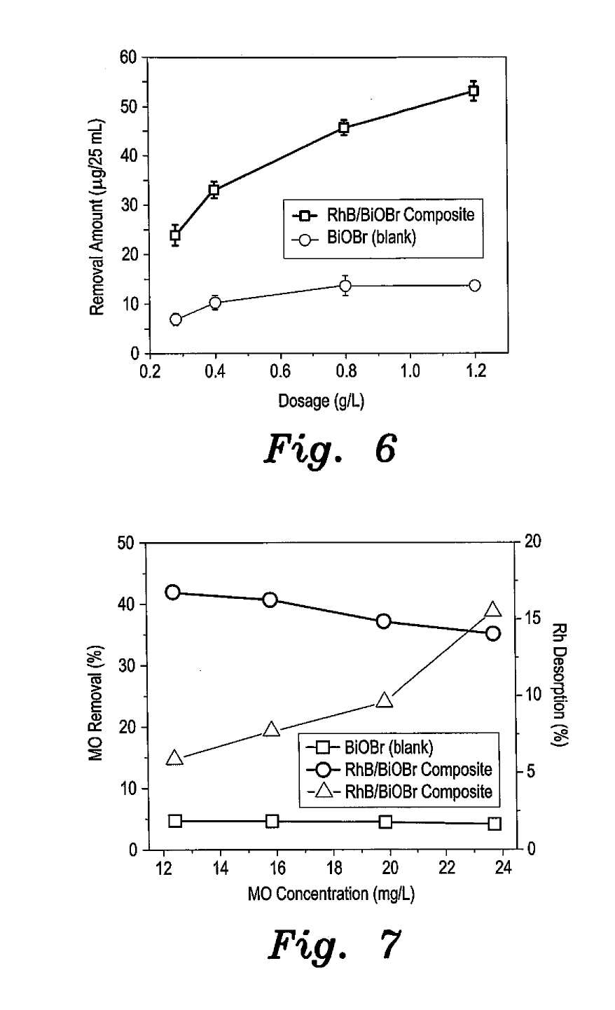

As shown in FIG. 6, the rhodamine B/BiOBr hybrid photocatalyst has greater photocatalytic efficiency to degrade MO under green light (λ=550±10 nm) irradiation as compared against BiOBr. As the dosage increases to 1.2 g/L, about 53 μg/25 mL of MO is removed using the rhodamine B/BiOBr hybrid photocatalyst, while there is only 13.6 μg removed using the BiOBr. The effect of dosage with the rhodamine B/BiOBr hybrid photocatalyst is stronger than with the BiOBr. As the dosage is in the 0.28 to 1.2 g/L range, the MO removal over the rhodamine B/BiOBr hybrid photocatalyst increases to 120% while it only increases 100% over BiOBr.

FIG. 7 and Table 3 below show the effect of MO initial concentration on the photodegradation removal performance over the rhodamine B/BiOBr hybrid photocatalyst and the BiOBr sample under visible light irradiation (λ>420 nm). The photodegradation removal performance of the rhodamine B/BiOBr hybrid photocatalyst and BiOBr both decrease with increasing concentrations of MO. As the MO concentration increases from 12.4 to 24 mg/L, the MO removal percentage decreases from 42% to 35% over the rhodamine B/BiOBr hybrid photocatalyst, while the removal performance decreased from 4.7% to 4.1% for the BiOBr. Table 3 below shows the percent degradation changes of MO by the rhodamine B/BiOBr hybrid photocatalyst (rhodamine B loading of 7 mg/g) and the conventional BiOBr photocatalyst as a function of catalyst dosage (irradiation time of 60 min, catalyst dosage of 0.01 g/25 mL).

TABLE 3
Percent Degradation Changes of MO by Hybrid Photocatalyst and BiOBr
Photocatalyst

Concentration (ppm)

| Photocatalyst | 12.4 | 15.8 | 19.8 | 23.8 |
|---|---|---|---|---|
| Rhodamine B/BiOBr | 42% | 40% | 37% | 35% |
| BiOBr | 4% | 4% | 4% | 4% |

The enhanced photodegradation of MO by the rhodamine B/BiOBr hybrid photocatalyst may be explained by the semiconductor mediated photodegradation (SMPD) mechanism. In SMPD, the rhodamine B acts as antennae to absorb visible light into the degradation system. The photodegradation process over the rhodamine B/BiOBr hybrid photocatalyst includes four main reactions steps: a) the rhodamine B molecules absorb visible light to be excited; b) the excited rhodamine B molecules inject electrons into the conduction band of the substrate BiOBr, forming conduction band electrons (e_{cb}⁻) and oxidized rhodamine B molecules (a much faster process than the photosensitization process of MO on BiOBr); c) the conduction band electrons e_{cb}⁻ are further scavenged by dissolved O₂ molecules to yield superoxide radical anions O₂⁻; and d) the final reaction is the reaction of superoxide radical anions O₂⁻ with MO in the bulk solution, resulting in degradation.

Using the rhodamine B/BiOBr hybrid photocatalyst as described above, the visible light preferably has a power intensity of at least 1 W/in². The light may be applied continuously, or in a pulsed manner, in which the light pulses have a duration of less than one second, and the light and dark phases of the pulsation having about equal durations. It should be understood that the rhodamine B/BiOBr hybrid photocatalyst may be used as described above or, alternatively, may be used in a powdered form adhered to a light-transparent surface, which may be immersed in wastewater or used to contain wastewater for treatment thereof.

It is to be understood that the present invention is not limited to the embodiments described above, but encompasses any and all embodiments within the scope of the following claims.

We claim:

1. A hybrid photocatalyst for wastewater remediation, comprising a composite of rhodamine B and BiOBr.

2. The hybrid photocatalyst for wastewater remediation according to claim 1, wherein the rhodamine B has a concentration between about 0.1 wt % and about 1 wt %.

3. A method of making a hybrid photocatalyst for wastewater remediation,
comprising the step of immersing a BiOBr semiconductor in an aqueous rhodamine B solution to form a hybrid photocatalyst through sorption of the rhodamine B by the BiOBr semiconductor.

4. The method of making a hybrid photocatalyst for wastewater remediation as recited in claim 3, wherein the step of immersing the BiOBr semiconductor in the aqueous rhodamine B solution comprises immersing the BiOBr semiconductor in an aqueous rhodamine B solution having a rhodamine B concentration between about 1 ppm and about 7 ppm.

5. The method of making a hybrid photocatalyst for wastewater remediation as recited in claim 3, wherein the step of immersing the BiOBr semiconductor in the aqueous rhodamine B solution is performed in the dark.

6. The method of making a hybrid photocatalyst for wastewater remediation as recited in claim 3, further comprising the step of washing the hybrid photocatalyst.

7. The method of making a hybrid photocatalyst for wastewater remediation as recited in claim 6, further comprising the step of drying the hybrid photocatalyst.

8. The method of making a hybrid photocatalyst for wastewater remediation as recited in claim 3, wherein the step of immersing the BiOBr semiconductor in the aqueous rhodamine B solution comprises immersing the BiOBr semiconductor in the aqueous rhodamine B solution for a period of between about 8 hours and about 12 hours.

9. A method of performing wastewater remediation using a hybrid photocatalyst, comprising the steps of:
adding a hybrid photocatalyst to wastewater containing at least one contaminant to form a suspension of the hybrid photocatalyst and the at least one contaminant, wherein the hybrid photocatalyst is a composite of rhodamine B and BiOBr;
exposing the suspension to visible light to form a slurry containing a reaction mixture in the wastewater; and
filtering the slurry to remove the reaction mixture.

10. The method of performing wastewater remediation according to claim 9, wherein the rhodamine B has a concentration between about 0.1 wt % and about 1 wt % in the composite.

11. The method of performing wastewater remediation as recited in claim 9, wherein the step of exposing the suspension to the visible light comprises exposing the suspension to light having a wavelength greater than 420 nm.

12. The method of performing wastewater remediation using a hybrid photocatalyst as recited in claim 9, wherein the step of exposing the suspension to the visible light comprises exposing the suspension to light having a wavelength in the range of 540 nm and 560 nm.

13. The method of performing wastewater remediation as recited in claim 9, wherein the step of exposing the suspension to the visible light comprises exposing the suspension to pulsed light.

14. The method of performing wastewater remediation as recited in claim 9, wherein the at least one contaminant comprises sodium 4[(4-dimethylamino)phenyldiazenyl]benzene sulfonate.
